(19) United States
(12) Patent Application Publication
(10) Pub. No.: US 2012/0323747 A1
(43) Pub. Date: Dec. 20, 2012

(54) AUTOMATED CASH RECONCILIATION AND REPORTING SYSTEM AND METHOD

(75) Inventors: Tohm Lim KANTIKOVIT, New York City, NY (US); Zeeshan Iftikhar AHMED, Chicago, IL (US); Neil Gavin MOORE, Pearland, TX (US); Rajendra DABBIRU, Katy, TX (US)

(73) Assignee: THE BANK OF NEW YORK MELLON, New York, NY (US)

(21) Appl. No.: 13/163,039

(22) Filed: Jun. 17, 2011

(51) Int. Cl. G06Q 40/00

(52) U.S. Cl. 705/30

(57) ABSTRACT

A system for reconciling financial data is configured to retrieve first and second financial data from respective data sources. The first and second financial data each contains one or more respective records, each containing a respective name, date, and monetary amount. The system attempts to match one of the first records with one of the second records, initially based on general equivalence of the names, dates, and the first and second monetary amounts. If any of the records remain unmatched, the system is configured to attempt to match two or more of the second records with one of the first records, utilizing the sum of the second monetary amounts, and attempt to match two or more of the first records with one of the second records based on the sum of the first monetary amounts.

### BACKGROUND

This application is directed to a computer-implemented system and method useful for reconciling account data with projected data in a financial system. In particular, this application is directed to a computerized system and method for efficiently reconciling collateralized debt obligation (“CDO”) projections with transactions from cash systems, and generating a report based upon the reconciliation.

CDOs are types of asset backed securities that comprise pools of collateral therein. In any given CDO, a variety of collateral that might be transferred is possible. For example, the collateral may include securities (including real-estate linked securities), leveraged loans, Treasury or Government bills, corporate and Treasury/Government bonds, stocks/shares, or other securities, financial instruments or debt. In CDOs, investors are divided into tiers of tranches (or risk classes) that are assigned to a given security. Typically, the more junior tranches are at higher investment risk than more senior tranches. As such, cash collected by the CDO is paid to the more senior tranches before the more junior tranches, putting the more junior tranches at greater risk of loss in the event that a CDO collects an insufficient amount.

In the CDO context, the party managing a CDO system might generally be the issuer of the CDOs (i.e. investment bank), and may earn a commission when issuing the CDO. Such a party may further earn management fees for managing the CDO, for example by controlling the movement of securities bundled within the CDO. In some cases, the CDO system manager may provide update reports to the CDO investors, and may wish to compare projected/expected transactions with completed transactions, so as to ascertain investment strength, for example.

In some financial systems that are operated by financial service providers, including CDO systems, separate subsystems may be configured to manage or otherwise assist in analyzing or processing the completed transactions and the projected/expected transactions. For example, a cash system may process and/or contain data regarding the completed transactions, while a portfolio or expectation system may process and/or contain data regarding pending or future transactions. The cash system may be coupled to or otherwise configured to access actual data for the financial transactions that have occurred. Alternatively, the portfolio system may be configured to access or otherwise contain information about money that the financial service provider expects to receive, and transactions that the financial service provider expects to occur. As an example, the expected transactions may come from pending sales or other transfers of assets, such as the collateral in CDOs. Due to reasons such as incompatibilities in the data formats used by cash conventional cash systems and portfolio systems, however, it may be difficult to reconcile expected and completed financial transactions. Such difficulties may be especially true where the cash and portfolio systems conform to differing standards, or are managed by differing entities (or sub-entities).

Among other things, what is needed is a system and method for managing financial transactions by reconciling the projected transaction results with actual transaction results. What is further needed is a computer-implemented system and method that simplifies and improves the generation of transaction results utilizing reconciled data.

### SUMMARY

Various embodiments of this disclosure may be used in conjunction with existing financial services platforms that utilize the reconciliation between projected cash flow data and transactions from cash systems.

In some embodiments, the operator/manager of the system and method of this disclosure acts as the party negotiating the financial transactions, while in other embodiments the operator/manager of the system and method acts as a third-party service provider to the investors and one or more traders, such that the various functions performed by the system and method provide value-added services which mitigate risk and lead to greater efficiencies for the investors and traders.

According to an embodiment, a system for reconciling financial transactions includes one or more processors. The one or more processors are configured to retrieve first financial data from a first data source, the first financial data containing one or more first records, each containing at least a first name, a first date, and a first monetary amount. The one or more processors are also configured to retrieve second financial data from a second data source, the second financial data containing one or more second records, each containing at least a second name, a second date, and a second monetary amount. The one or more processors are further configured to attempt to match one of the first records with one of the second records based on (i) equivalence of the first name, or a possible alias of the first name, and the second name, (ii) equivalence within tolerance of the first date and the second date, and (iii) equivalence within tolerance of the first monetary amount and the second monetary amount. Responsive to any of the first records and the second records remaining unmatched, the one or more processors are configured to attempt to match two or more of the second records with one of the first records based on (i) equivalence of the first name, and/or possible aliases of the first name, and the second names, (ii) equivalence within tolerance of the first date and the second dates, and (iii) equivalence within tolerance the first monetary amount and a sum of the second monetary amounts. Responsive to any of the first records and the second records remaining unmatched, the one or more processors are configured to attempt to match two or more of the first records with one of the second records based on (i) equivalence of the first names and the second name, (ii) equivalence within tolerance of the first dates and the second date, and (iii) equivalence within tolerance of the sum of the first monetary amounts and the second monetary amount.

According to another embodiment, a computer-implemented method for reconciling financial transactions includes retrieving, via one or more processors, first financial data from a first data source, the first financial data containing one or more first records, each containing at least a first name, a first date, and a first monetary amount. The method also includes retrieving, via the one or more processors, second financial data from a second data source, the second financial data containing one or more second records, each containing at least a second name, a second date, and a second monetary amount. The method additionally includes attempting to match one of the first records with one of the second records based on (i) equivalence of the first name, or an alias of the first name, and the second name, (ii) equivalence within tolerance of the first date and the second date, and (iii) equivalence within tolerance of the first monetary amount and the second monetary amount. Responsive to any of the first records and the second records remaining unmatched, the method additionally includes attempting to match two or more of the second records with one of the first records based on (i) equivalence of the first name, and/or aliases of the first name, and the second names, (ii) equivalence within tolerance of the first date and the second dates, and (iii) equivalence within tolerance the first monetary amount and a sum of the second monetary amounts. Responsive to any of the first records and the second records remaining unmatched, the method further includes attempting to match two or more of the first records with one of the second records based on (i) equivalence of the first names and the second name, (ii) equivalence within tolerance of the first dates and the second date, and (iii) equivalence within tolerance of the sum of the first monetary amounts and the second monetary amount.

The system and method of this disclosure provides various capabilities as discussed more fully in the detailed description below.

### BRIEF DISCUSSION OF THE DRAWINGS

FIG. 1 provides a functional block diagram of an embodiment of a computer-implemented and networked system for financial transaction reconciliation;

FIG. 2 illustrates an embodiment of a high level logic flowchart that provides for selecting whether to set up deals, perform a transformation/reconciliation; process exceptions; or generate reports;

FIG. 3 illustrates an embodiment of a deal setup process that may be called by the high level flowchart of FIG. 2;

FIG. 4 illustrates an embodiment of a transformation/reconciliation process that may be called by the high level flowchart of FIG. 2;

FIG. 5 illustrates an embodiment of a cash flow file generation process that may be called by the high level flowchart of FIG. 2;

FIGS. 6A-C illustrate an example of a cash flow file that may be generated by the cash flow file generation process of FIG. 5;

FIG. 7 illustrates an embodiment of an exception process that may be called by the high level flowchart of FIG. 2;

FIG. 8 illustrates an embodiment of matching logic that may be utilized to match records to reconcile financial transactions; and

FIG. 9 provides an illustrative screen shot representing an alias definition screen that may be used in a graphical user interface of an embodiment of this disclosure to establish aliases that may be utilized by the matching logic of FIG. 8.

### DETAILED DESCRIPTION

In the discussion of various embodiments and aspects of the system and method of this disclosure, examples of a processor may be embodied in any one or more of, for instance, a personal computer, portable computer, personal digital assistant (PDA), workstation, or other processor-driven device, and examples of network may include, for example, a private network, the Internet, or other known network types, including both wired and wireless networks.

Those with skill in the art will appreciate that the inventive concept described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include non-transitory read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

Described herein is an exemplary algorithm which may be implemented through computer software running in a processor to reconcile completed transactions with estimated or projected transactions based on a variety of criteria. This algorithm is not intended to be limiting, but is merely provided to describe one way of accomplishing the functions associated with reconciling the completed and projected transactions.

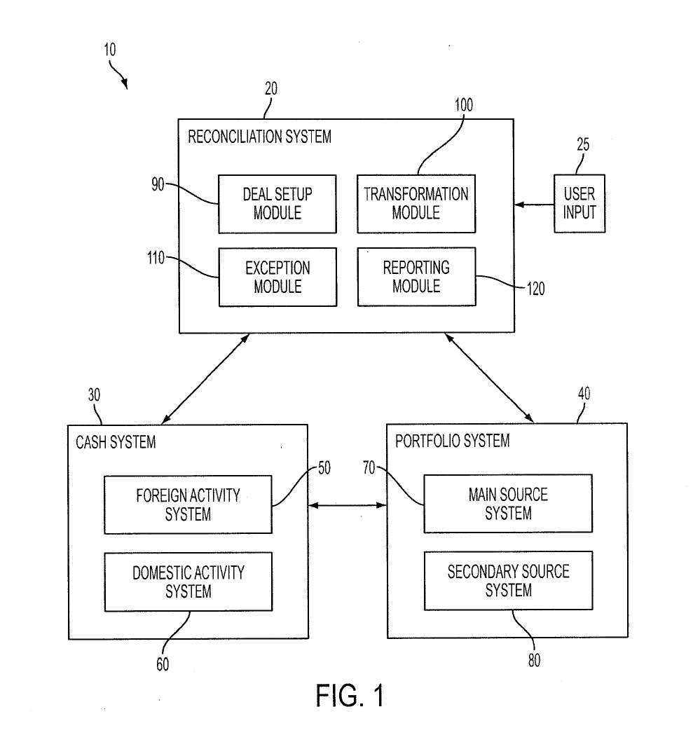

FIG. 1 depicts financial service system 10 that includes reconciliation system 20, cash system 30, and portfolio system 40. Reconciliation system 20, which may include, be configured to receive, or otherwise be connected to user input 25, is described in greater detail below. User input 25 may be of any appropriate configuration, including but not limited to an associated user interface attached to reconciliation system 20 (i.e. a monitor, keyboard, and/or mouse), or a client computer associated with reconciliation system 20 (either through a local network or a wide area network). User input 25 may further include a graphical user interface, which may be displayed via any appropriate mechanism, including but not limited to a web-browser, dedicated software, or so on. Cash system 30 may be any system, subsystem, or module that is configured to receive and/or process data pertaining to financial transactions that have occurred. For example, cash system 30 may comprise a wire or account system that is operatively coupled to databases that manage cash transaction for a plurality of funds. In some embodiments, cash system 30 may be configured to periodically or upon request compile account activity that has taken place for a duration of time (i.e. the present day's transactions). The account activity data that is compiled may be of any appropriate type, including but not limited received cash, confirmed losses, and so on. In some embodiments, cash system 30 may include foreign exchange rates and other market data. The account activity data associated with cash system 30 may further include identifier information, such as, but not limited to, issuer name information. In some embodiments, cash system 30 may include multiple subsystems, which may segregate cash system 30 by any number of criteria. For example, in some embodiments, separate subsystems in cash system 30 may be provided for domestic activities and foreign/international activities. In the illustrated embodiment, cash system 30 includes therein foreign activity system 50 and domestic activity system 60. Although in the illustrated embodiments foreign activity system 50 and domestic activity system 60 are together part of cash system 30, in other embodiments each of foreign activity system domestic activity system may separately be coupled to reconciliation system 20 and/or portfolio system 40.

Portfolio system 40 of the financial service system 10 may be of any appropriate configuration that houses portfolios for the funds under the financial service system 10. For example, in an embodiment portfolio system 40 may contain records concerning what a fund (such as a CDO) holds, such as assets and prior cash data therein. In some embodiments, the portfolio system 40 may contain asset market identifiers, such as but not limited to Committee on Uniform Security Identification Procedures (CUSIPS) identifiers, International Securities Identification Numbers (ISINS) identifiers, and LX (formerly LoanX) identifiers. In some embodiments, portfolio system 40 may contain asset ratings or industry classifications therein. In some embodiments, portfolio system 40 may contain therein transactional information such as projections regarding the funds (including but not limited to interest and principal projections). In some embodiments, portfolio system 40 may be configured to utilize the records to generate reports, including but not limited to periodic compliance reports, pertaining to the fund. In some embodiments, the compliance reports may be a contractual obligation on the part of the service provider with the fund investors. In other embodiments, the compliance reports may be government mandated (i.e. through SEC regulations). As is shown in the illustrated embodiment, in some embodiments portfolio system 40 may contain therein multiple subsystems. For example, in some embodiments, portfolio system 40 contains main source system 70 and secondary source system 80, which may contain records therein for different categories of funds. In some embodiments, main source system 70 and secondary source system 80 may be categorized differently. For example, secondary source system 80 may comprise a legacy database structure that is incompatible with main source system 70. In some embodiments, main source system 70 may comprise a SQL based server, while secondary source system 80 may comprise an Oracle based server. In some embodiments, main source system 70 may be a master repository for all loan asset type information, irrespective of a reporting platform, may hold Bond asset type information, and may produce compliance reports therein. In some embodiments, secondary source system 80 may hold unique income and asset information with respect to Bond asset types where secondary reporting (i.e. legacy reporting, or other types of report generation) is utilized.

The interconnections within financial service system 10 may be of any suitable type. For example, in some embodiments, financial service system 10 may be located on a single computer containing one or more processors. As such, the interconnections may be process threads within the single computer, on or between the one or more processors, memory elements, and data storage elements. In other embodiments, financial service system 10 may be spread across multiple computers. For example, in some embodiments financial service system 10 may be located across a network, whereby multiple computers, each containing one or more processors, may be interconnected. In some embodiments, one or more of reconciliation system 20, cash system 30, and portfolio system 40 may be located on one or more processing systems coupled to but spaced from the others. Such coupling may be through cables, wires, or wireless transmissions of any type.

Further shown in FIG. 1 is that in some embodiments reconciliation system 20 may contain therein one or more modules configured to analyze and process data associated with cash system 30 and/or portfolio system 40. In some embodiments the data may be transferred (i.e. copied or moved) from cash system 30 and/or portfolio system 40 to be analyzed and processed at reconciliation system 20, while in other embodiments, at least some of the data may be accessed directly at cash system 30 and/or portfolio system 40. As indicated above, reconciliation system 20 may be configured to reconcile completed financial transactions associated with cash system 30 with deals and accounts associated with portfolio system 40. In some embodiments, at least a portion of reconciliation system 20 may be configured to provide front-end access to cash system 30 and/or portfolio system 40, as described in greater detail below.

In the illustrated embodiment, reconciliation system 20 includes therein deal setup module 90, transformation module 100, exception module 110, and reporting module 120. In some embodiments each of these modules may be interconnected. In some embodiments, one or more of the modules of reconciliation system 20 may partially or completely overlap in terms of functionality, and/or one or more of the modules may be a sub-module of one or more of the other modules.

In some embodiments, deal setup module 90 may be configured to allow for the initial setup or amendments of deals. In an embodiment, deal setup module 90 may be configured to add new data elements to data within reconciliation system 20 (or systems associated with reconciliation system 20, such as portfolio system 40). In some embodiments, deal setup module 90 may be configured to control access control levels for users of reconciliation system 20 pertaining to each deal. In some embodiments, deal setup module 90 may be configured to permit storage of deal specific information (such as contact information for parties associated with the deals/accounts) which might not be located on cash system 30 or portfolio system 40. In an embodiment, reconciliation system 20 may be configured such that a user may define accounts associated with cash system 30, including, for example, accounts in foreign activity system 50 or accounts in domestic activity system 60. In some embodiments, some or all of the users of reconciliation system 20 may be permitted to add or edit account numbers, add or edit account types (i.e. principal or interest), add or edit groups of the accounts, change account priority designators, or so on. In some embodiments, deal setup module 90 may be configured to access existing deals, and copy data from those deals into a new deal, such that the new deal may be edited accordingly. In some embodiments, deal setup module 90 may be configured to determine how deals are treated on reconciliation system 20. For example, in an embodiment, deal setup module 90 may allow configuration of how the other modules of reconciliation system 20 operate with respect to particular deals, as described in greater detail below.

In an embodiment, deal setup module 90 may be configured to permit users to associate ledgers and account numbers from cash system 30 to a deal. In an embodiment, deal setup module 90 may be configured to permit users to associate a deal's ledger account from portfolio system 40 and cash accounts from cash system 30 as a primary collection account. In an embodiment, deal setup module 90 may be configured to permit bucketing of deals, such as by allowing associated groups of deals to be linked. In an embodiment, certain account types may be grouped into discrete buckets, such as interest, principal, and par, for example. In some embodiments, deal setup module 90 may be configured to permit selection of parameters for a reconciliation process performed in transformation module 100, such as that described in greater detail below. Additionally shown in reconciliation system 20 is exception module 110, which may be configured to manage non-reconcilable or otherwise un-reconciled deals, and may operate in coordination with transformation module 100. Furthermore, in some embodiments, deal setup module 90 may be configured to permit selection of parameters for generation of reports based on the transformation/reconciliation, through reporting module 120, for example, which may be configured to perform a reporting process such as that described in greater detail below.

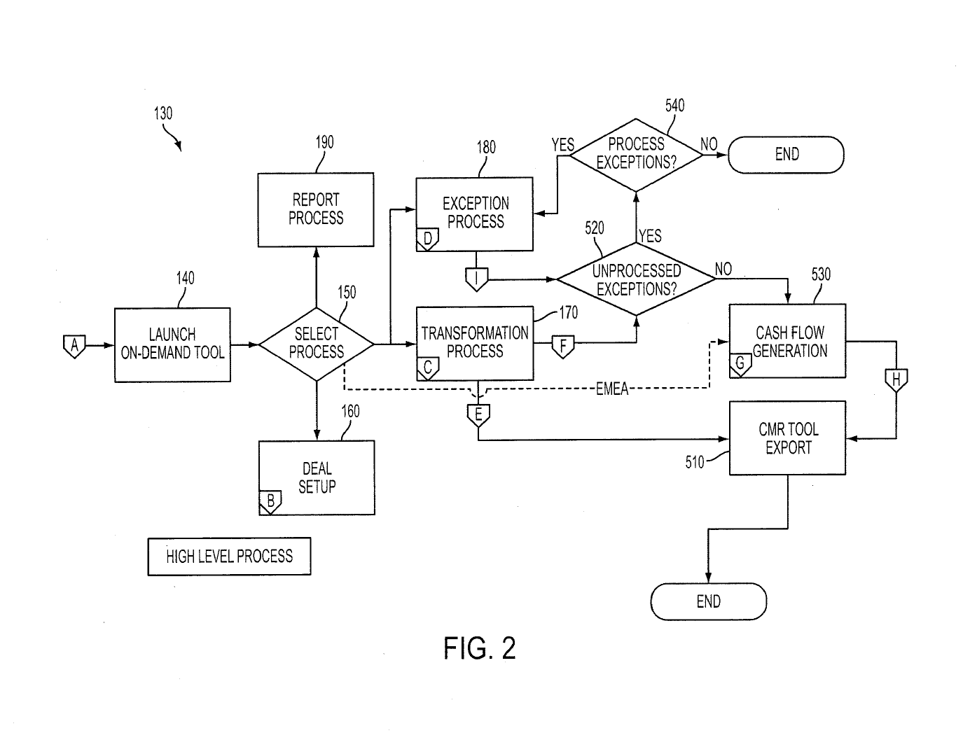

Shown in FIG. 2 is high level process 130 for operation on reconciliation system 20. As depicted, high level process 130 may begin at node “A” with launching an on-demand tool at 140. In some embodiments, launching the on-demand tool at 140 may be responsive to user input on reconciliation system 20, while in other embodiments, launching the on-demand tool at 140 may comprise a computer system call from any appropriate source. As shown, in some embodiments sub-processes called by high level process 130 may return to node “A,” by subsequently launching the on-demand tool at 140. After the on-demand tool is launched at 140, high level process 130 may continue by permitting selection of a sub-process at 150, including but not limited to launching deal setup process 160 by proceeding to node “B,” launching transformation process 170 by proceeding to node “C,” launching exception process 180 by proceeding to node “D,” or launching reporting process 190, each of which is described in greater detail below. In some embodiments, launching deal setup process 160 at “B,” launching transformation process 170 at “C,” launching exception process 180 at “D,” or launching reporting process 190, may comprise respectively calling deal setup module 90, transformation module 100, exception module 110, or reporting module 120, of reconciliation system 20.

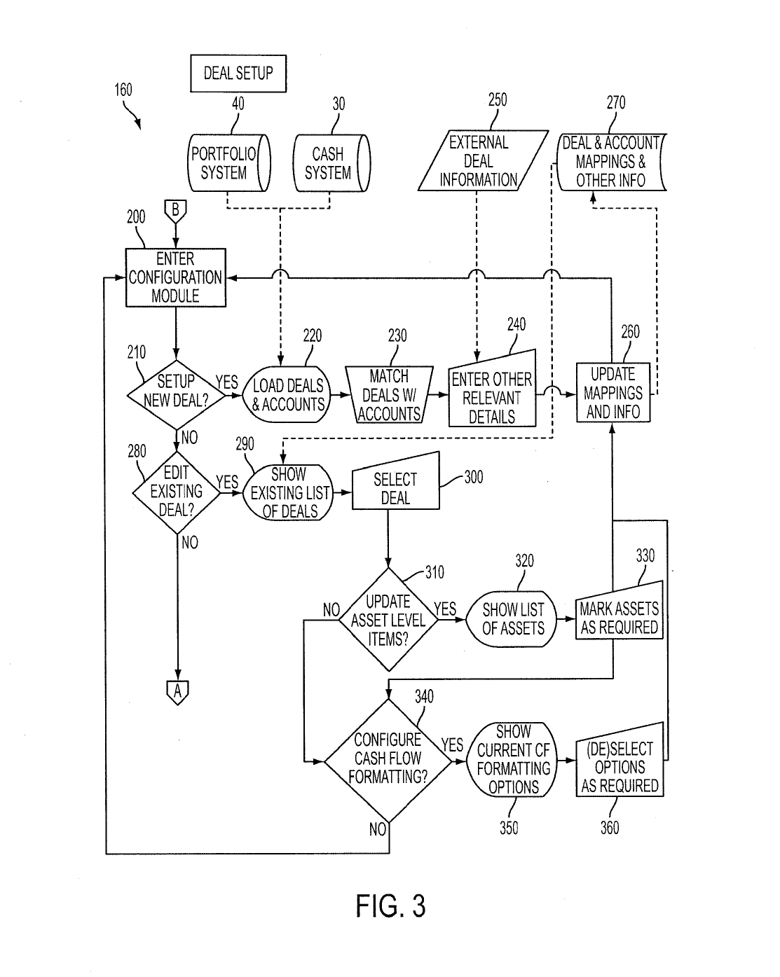

If, in selecting a sub-process at 150, deal setup process 160 is selected, then method 130 may proceed to “B,” as depicted in expanded form in FIG. 3. As shown, deal setup process 160 may begin with entering a configuration module at 200. In various embodiments, the configuration module may be a user interface of any suitable type, including but not limited to text based, graphical, network-based, web-based, or so on, that permits setting up or editing a deal. For example, in an embodiment, the configuration module may be operatively coupled to user input 25 associated with reconciliation system 20. In an embodiment, deal setup process 160 may continue at 210 by determining if a new deal is to be set up. If so, then deals and accounts may be loaded at 220. As shown schematically, loading deals and accounts at 220 may comprise pulling the deals and accounts data in from cash system 30 and portfolio system 40. Deal setup process 160 may then continue at 230 by matching the deals with accounts, as described in greater detail below, and allowing input of other relevant details pertaining to the deals and accounts at 240. As shown, external deal information 250 may be input at when entering other relevant details at 240. Entry of external deal information 250 may be by any appropriate mechanism, including but not limited to manual user entry, retrieval from another database or memory store, or so on. Once other relevant details are entered at 240, deal setup process 160 may continue by updating mappings and other information at 260. In some embodiments, the mappings and other information may be understood comprise some or all of the external deal information 250, as associated with the deals and accounts, bucketing information, information regarding the matched deals and accounts, or so on. As shown, once updated at 260, deal and account mappings and other information 270 may be stored for subsequent retrieval, as described in greater detail below. Further shown is that once mappings and other information have been updated at 260, deal setup process 160 may return to entering the configuration module 200, as described above.

If a new deal is not being set up at 210, then deal setup process 160 may continue by determining if an existing deal is to be edited, at 280. If an existing deal is to be edited at 280, then the existing deals may be presented, at 290, such as by being listed for display to the user of reconciliation system 20. As shown in the embodiment of FIG. 3, presenting the existing deals at 290 may include loading deal and account mappings and other information 270 previously stored. In an embodiment, deal setup process 160 may continue by selecting a deal at 300, and determining at 310 whether asset level items associated with the deal are to be updated. If asset level items are to be updated, then assets may be presented at 320, and may be subsequently marked at 330. Once marked, the mappings and information may again be updated at 260, as shown, and stored with deal and account mappings and other information 270. If asset level items are not selected for updating at 310, or in some embodiments once assets are marked as required at 330, it may be determined whether cash flow formatting is to be configured at 340. If so, then current cash flow formatting options may be presented at 350, and cash flow options may be selected or deselected as required at 360. Once cash flow options are selected or deselected at 360, the mappings and information may again be updated at 260, as shown, and stored with deal and account mappings and other information 270. If cash flow formatting is not selected for configuration at 340, then deal setup process 160 may return entering the configuration module at 200. If no new deals are to be set up at 210, and no existing deals are to be edited at 280, then deal setup process 160 may terminate, and return to A of high level process 130, wherein the on-demand tool may be launched at 140.

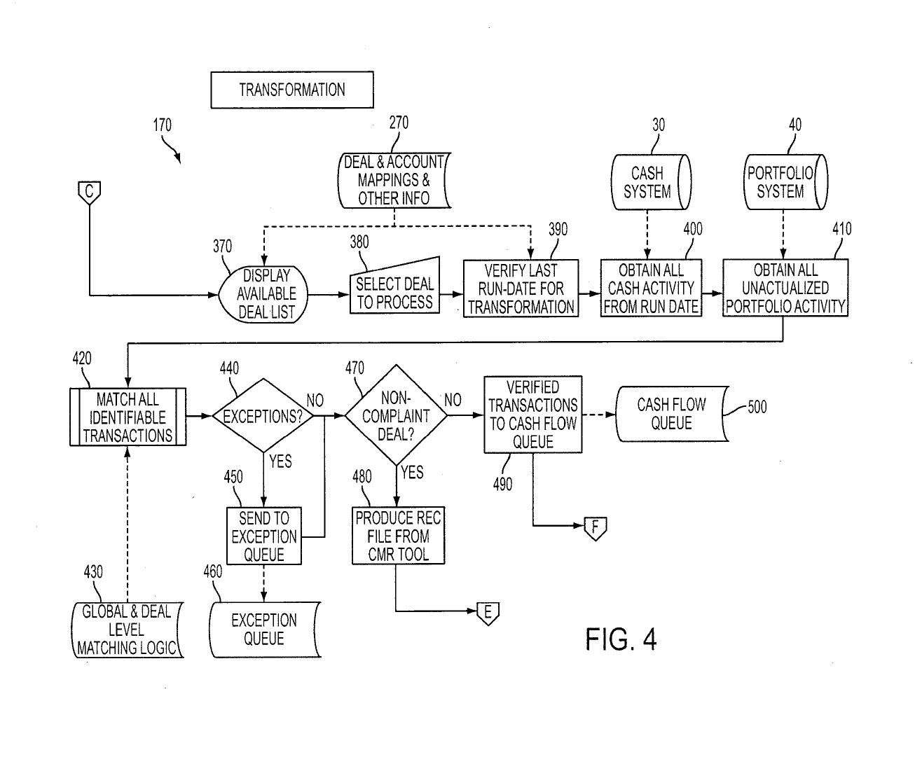

If, in selecting a sub-process at 150, transformation process 170 is selected, then method 130 may proceed to “C,” as depicted in expanded form in FIG. 4. As shown, transformation process 170 may begin by presenting an available deal list at 370 which, in an embodiment may include loading some or all of deal and account mappings and other information 270. In an embodiment, transformation process 170 may continue at 380, wherein a deal from the presented list in 370 is selected. In an embodiment the selection at 380 may include user-selection, automatic selection based on predetermined criteria, or so on. In an embodiment, transformation process 170 may continue at 390 by verifying the last run date for the transformation process 170, which may be stored with deal and account mappings and other information 270. In an embodiment, such verification at 390 may be performed so as to prevent duplicative reconciliation during transformation process 170. In an embodiment, transformation process 170 may continue at 400 by obtaining cash system activity from cash system 30 that has occurred subsequent to the last run-date for the transformation process (as verified at 390). Transformation process 170 may further proceed at 410 by obtaining unactualized activity from portfolio system 40. Once the cash activity subsequent to the prior reconciliation/transformation and the unactualized portfolio activity is obtained at 400 and 410, transformation process 170 may continue by matching all identifiable transactions at 420. In an embodiment, matching all identifiable transactions at 420 may comprise utilizing global and deal level matching logic 430. In some embodiments, global and deal level matching logic 430 may additionally be utilized in matching deals with accounts at 230 during deal setup process 160.

In an embodiment, once all identifiable transactions 420 have been matched, it may be determined if there are exceptions at 440. In an embodiment, the exceptions at 440 may comprise deals, accounts, cash activity, and/or portfolio activity that could not be matched at 420. If there are exceptions, then at 450 the exceptions may be sent to exception queue 460, as shown in FIG. 4. Once exceptions are sent at 450 to exception queue 460, or if there are no exceptions at 440, it may be determined if any of the deals are non-compliant deals at 470. For example, in an embodiment, a deal might be one that is not recognized or otherwise handled by cash system 30. In a more specific example, deals from certain countries may be excluded from foreign activity system 50 of cash system 30. In still other examples, the deals may be foreign transactions with delayed reporting, and as such may be stored for subsequent matching (i.e. during the next day's processing). If the deal is non-compliant at 470, then the process 170 may proceed by producing an associated reconciliation file at 480, and conclude by proceeding to node “E” on high level process 130, described in further detail below. If the deal is not found to be non-compliant at 470, then transformation process 170 may continue at 490, whereby verified transactions are output to cash flow queue 500, and transformation process 170 ends by proceeding to node “F” on high level process 130, also described in further detail below.

Returning to FIG. 2, it is seen that if transformation process 170 ends by proceeding to “E” after producing the reconciliation file at 480, high level process 130 may proceed with cash manager reconciliation exportation at 510, whereby the reconciliation file may be exported. In an embodiment, the cash manager reconciliation file may contain information about associated deals placed therein, including but not limited to book date, issuer name, facility name, facility identifier number, transaction amount, and/or interest/principal bucket, which may be subsequently utilized by the user of reconciliation system 20. If, however, transformation process 170 concludes by proceeding to “F” after storing verified transactions at 490 to cash flow queue 500, then high level process 130 may continue at 520 by determining if there are unprocessed exceptions. If there are no unprocessed exceptions, then high level process 130 may proceed to cash flow file generation 530, described in greater detail below. If there are unprocessed exceptions at 520, then high level process 130 may proceed at 540 by determining if exceptions should be processed at that time. If not, then high level process 130 might end, including by terminating, or by returning to “A” and launching the on demand tool at 140. If Exceptions are to be processed at 540, then high level process 130 may proceed by performing the exception process 180 at node “D,” as described below.

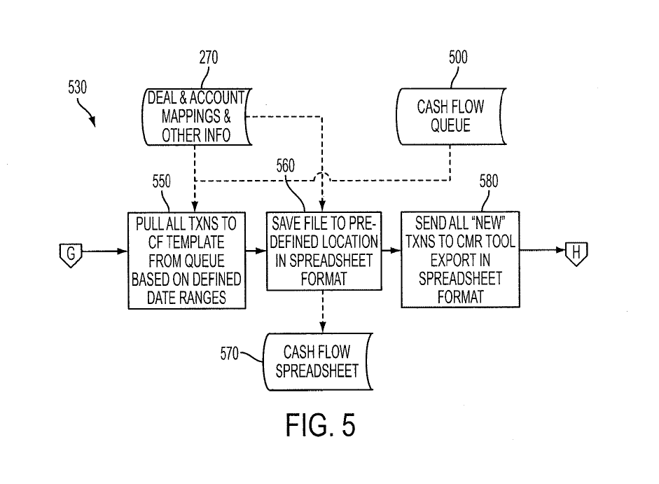

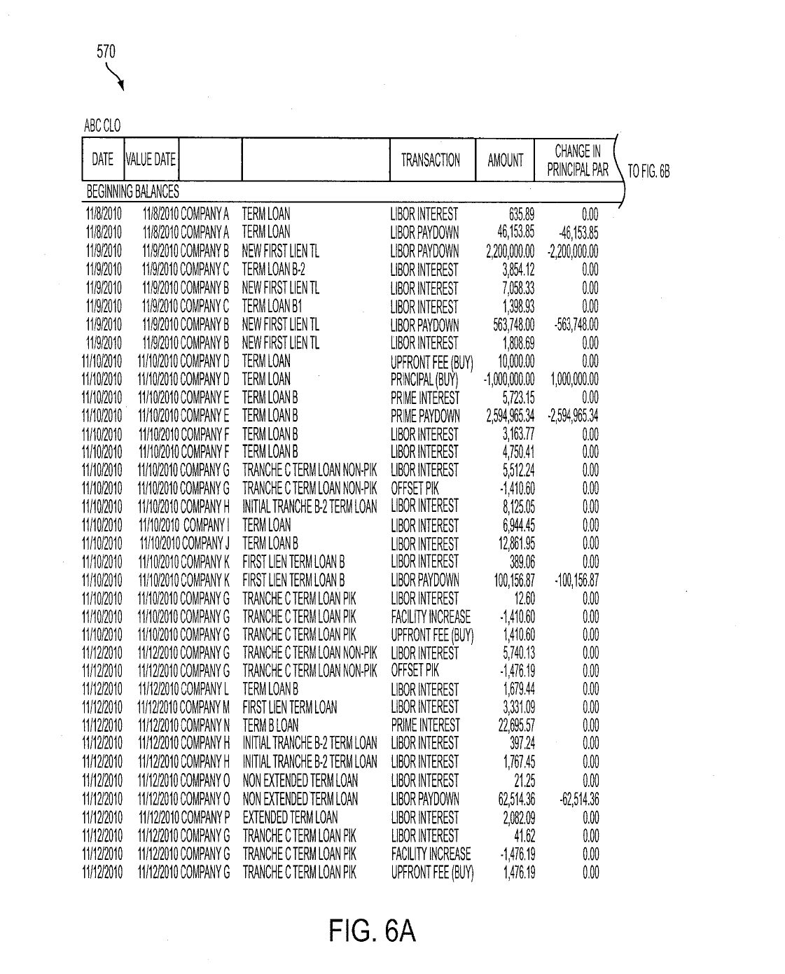

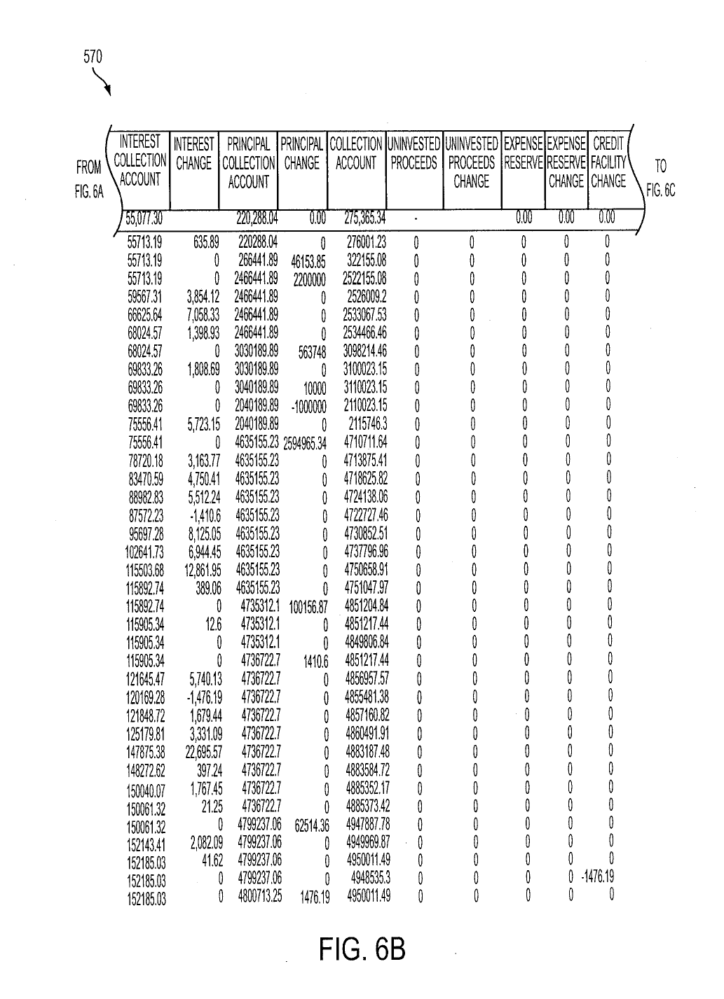

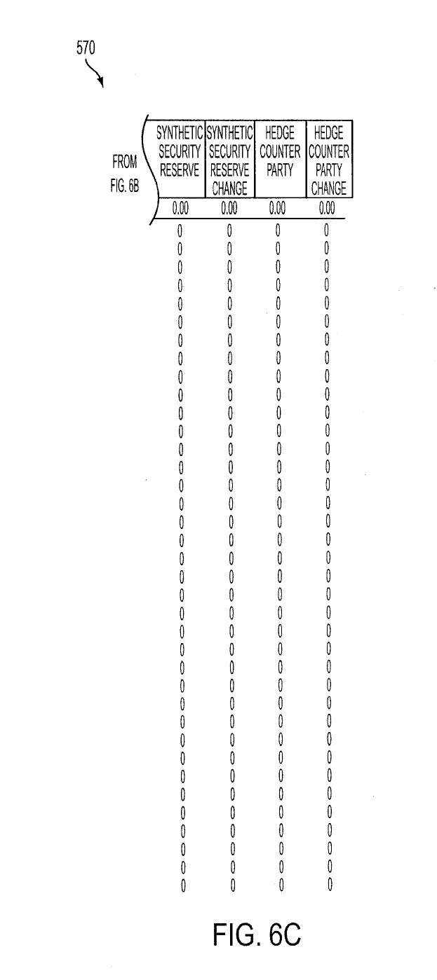

Shown in FIG. 5 is an embodiment of cash flow file generation 530. As shown in the illustrated embodiment, cash flow file generation 530 may begin at “G,” and proceed to 550, whereby transactions TXNS may be pulled to a cash flow template from cash flow queue 500 based on desired date ranges. In an embodiment, the date ranges may be verified based on deal and account mappings and other information 270, as described above. In an embodiment, cash flow file generation 530 may proceed at 560 by saving the cash flow template to a predefined location in a spreadsheet format as cash flow spreadsheet 570. One non-limiting embodiment of cash flow spreadsheet 570 is depicted in FIGS. 6A-C. It should be understood that the values filled into cash flow spreadsheet 570 may be collected, computed, or reported by any suitable process, and that in various embodiments the columns listed may vary. The data columns provided in cash flow spreadsheet 570 may be user-definable (through deal setup process 160, or through any other setup screen) or may be fixed. In an embodiment, the predefined location may be obtained or determined from deal and account mappings and other information 270. As shown in the illustrated embodiment, cash flow file generation 530 may then proceed at 580 by sending all new transactions to cash manager reconciliation exportation at 510, before proceeding to node “H,” which returns to the high level process 130, and loading cash manager reconciliation exportation at 510.

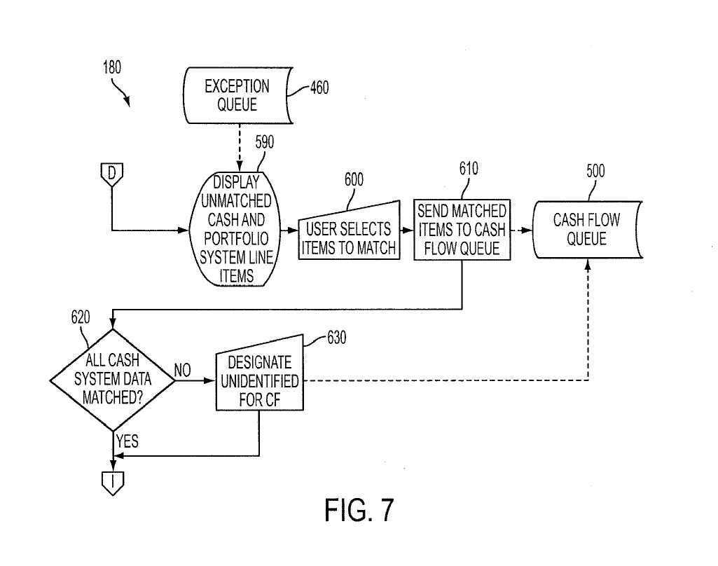

FIG. 7 illustrates an embodiment of exception process 170, which in various embodiments may be selected directly from high level process 130 through selection at 150, or may be loaded following transformation process 170, after it is determined if there are unprocessed exceptions at 520, and if exceptions are to be processed at 540. As shown in FIG. 7, exception process 180 may begin at node “D,” and continue at 590 by loading and displaying unmatched line items from exception queue 460. At 600, the user may be prompted to select items displayed at 590 to match. Proceeding to 610, matched items may be sent to cash flow queue 500, removing them from the exception queue 460. Exception process 180 may subsequently proceed at 620 to determine if all data from cash system 30 has been matched. If not, then the unidentified data from cash system 30 may be designated at 630 as such in cash flow queue 500. If it is determined at 620 that all cash system data is matched, however, then exception process 180 may terminate by returning to node “I,” which as shown in high level process 130 may proceed to determine at 520 if unprocessed exceptions remain. Although in the illustrated embodiment of exception process 180 terminates by returning to node “I,” in other embodiments exception process 180 may return to “A” by launching the on-demand tool at 140. In some embodiments, exception process 180, or other processes called by exception module 110, may be configured to allow users to manually unlink records that have been previously reconciled. In an embodiment, a history of the reconciliation may be recorded for a user to view and an audit trail of associated usernames and dates/timestamps may apply to the unlinked records.

As indicated above, and depicted in FIG. 2, in an embodiment high level process 130 may allow for selection at 150 of report process 190. In various embodiments, report process 190 may comprise generating, editing, or transmitting reports or other documents prepared by high level process 130 or otherwise associated with reconciliation system 20. In some embodiments, report process 190 may be configured to prepare for transmission cash flow spreadsheet 570, or other outputs of cash flow file generation 530. In some embodiments, reports based on exception queue 460 may alternatively or additionally be prepared by report process 190. In an embodiment, management reports associated with the operation of high level process 130 and/or reconciliation system 20 may be generated or otherwise prepared therein, for reference by users of reconciliation system 20 or other associated systems in financial services system 10.

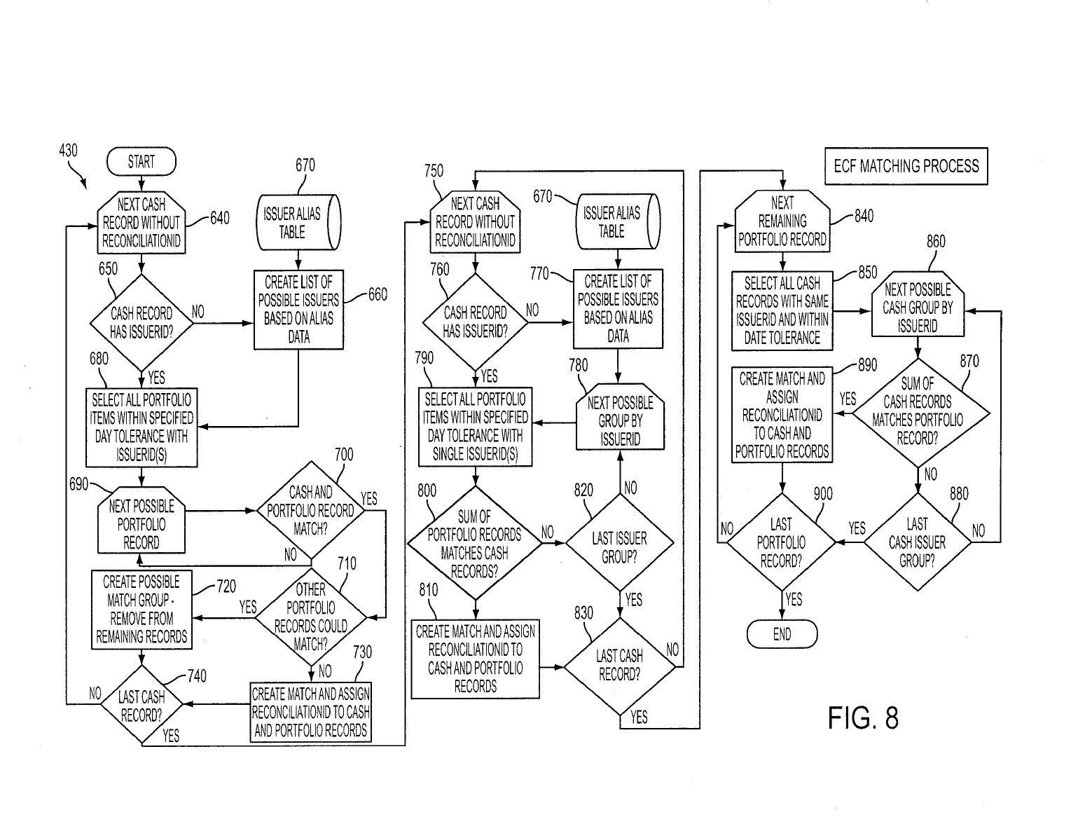

In the embodiment of transformation process 170 described above, global and deal level matching logic 430 is utilized to match identifiable transactions at 420. As further described above, such matching logic 430 may additionally be utilized during deal setup process 160, to match deals with accounts at 230 when setting up new deals. An embodiment of matching logic 430 is depicted in greater detail in FIG. 8. As shown in the illustrated embodiment, matching logic 430 starts at 640, whereby an un-reconciled record from cash system 30 is loaded for matching. In some embodiments, when loading the cash data from cash system 30, certain cash data may be excluded based on exclusion rules which may be established during the deal setup process 160. In an embodiment, only those cash records from cash system 30 having a deal identifier assigned based on a match of a cash account number in the cash record and an account number defined in the deal settings of reconciliation system 20 will proceed through transformation process 170, while cash records that cannot be matched with a deal identifier may be ignored throughout transformation process 170. In some embodiments, an asset identifier may be mapped to the cash record from cash system 30, which may be utilized to attempt to match with an asset identifier in an administrative database. In an embodiment, if such a match is confirmed, the issuer identifier may be assigned to the cash record, regardless of whether the cash record is reconciled by matching logic 430.

In an embodiment where reconciled records have an associated reconciliation identifier (i.e. “ReconciliationID” in FIG. 8), matching logic 430 may be configured to load those records from cash system 30 that lack the reconciliation identifier. In some embodiments, the cash records loaded from cash system 30 may be those having an associated activity date that begins at the last run date, as shown at 400 in FIG. 4. Once the record is loaded at 640, then it may be verified at 650 whether the cash record has an issuer identifier (i.e. “IssuerID” in FIG. 8). If there is no current issuer identifier, then a list of possible issuers may be created at 660, which in an embodiment may be based on alias data loaded from issuer alias table 670, described in greater detail below.

If an issuer identifier is found at 650, or once a list of possible issuers is created at 660, then matching logic 430 may proceed at 680 by selecting portfolio items within a defined day tolerance from portfolio system 40 that have an associated issuer identifier or identifiers. In an embodiment, the date tolerance may be a range plus or minus a given date (i.e. for a record, or for the starting or ending points of a date range). In an embodiment, the day tolerance may be a global setting that allows users to specify the number of days apart the effective/receive dates of cash and portfolio records may be considered as a match. In some embodiments, a deal specific day tolerance may be utilized in lieu of or to override the global day tolerance. Matching logic 430 may proceed at 690 by proceeding to the next possible portfolio record (starting with the first portfolio record), and determining at 700 if the cash record and the portfolio record match. In an embodiment, this matching at 700 may be characterized as a one-to-one reconciliation. In an embodiment, such matching may be a pure equivalence between issuer identifier, or the issuer identifier on portfolio system 40 and one of the possible aliases from issuer alias table 670. If no match is found between the cash record and the portfolio record, then matching logic 430 may return to 690 and advance to the next possible record from portfolio system 40. If, however, a match is determined between the cash record from cash system 30 and the portfolio record from portfolio system 40, then matching logic 430 may proceed to determine at 710 if other records from portfolio system 40 may also match with the cash record from cash system 30. In an embodiment, if it is determined at 710 that other records from portfolio system 40 could also match at 700, then matching logic 430 may proceed at 720 by creating a possible match group, and remove those records from the remaining cash records imported from cash system 30. If, however, no other portfolio records could match at 710, the matching logic 430 may proceed at 730 to create a match, and assign a reconciliation identifier to the cash record from cash system 30 and the portfolio record from portfolio system 40.

In an embodiment, if it is determined at 740 that there are additional cash records to be processed, then matching logic 430 may return to 640 to find the next cash record without a reconciliation identifier. If, however, all desired cash records lacking a reconciliation identifier have been processed in the one-to-one reconciliation pass, then matching logic 430 may proceed to 750, whereby it would proceed to load the next un-reconciled record from cash system 30. At 760 it would be determined if the particular cash record has an issuer identifier. If there is no issuer identifier associated with the cash record, then a list of possible issuers may again be created at 770, which in an embodiment may again be based on alias data loaded from issuer alias table 670. Matching logic 430 may then proceed to 780 to select the next possible issuer group by issuer identifier. Using the cash record issuer identifier established at 760, or the issuer group selected from the possible issuer groups at 780, matching logic 430 may continue at 790 by selecting portfolio items within the specified day tolerance with a single issuer identifier. It may then be determined at 800 if the sum of portfolio records matches the cash record. In an embodiment, this matching may be characterized as a many-to-one reconciliation. If a match is determined at 800, then the match may be created at 810, and the reconciliation identifier may be assigned to the cash and portfolio records. In an embodiment, if multiple issuer groups are found which match the cash record at 800 (i.e., issuer A and issuer B have similar groups of expected cash in the portfolio record from portfolio system 40 which appear to match the cash record from cash system 30), then a reconciliation group might not be created. If a match is not determined between the sum of the portfolio records and the cash record, then it may be determined at 820 if there are additional issuer groups. If so, then matching logic 430 may return back to 780, whereby the next possible issuer group by issuer identifier is selected, and the selection of the portfolio items within the day tolerance having a single issuer identifier is again selected at 790, before the many-to-one matching for the new possible issuer group is determined at 800.

If either there are no additional issuer groups determined at 820, or if a match is created at 810, then it may be determined at 830 if there are additional cash records to be processed. If so, then matching logic 430 may return to 750 to find the next cash record without a reconciliation identifier. If, however, all desired cash records lacking a reconciliation identifier have been processed in the one-to-one reconciliation pass and the many-to-one reconciliation pass, then matching logic 430 may proceed to 840, whereby it would proceed to load the next remaining portfolio record from portfolio system 40 (starting with a first remaining portfolio record). After the portfolio record is loaded at 840, then all cash records with the same issuer identifier and within the same date tolerance may be selected at 850, and the next possible cash group by issuer identifier (also starting with a first one) may be selected at 860. It may then be determined at 870 if the sum of the cash records matches the portfolio record loaded at 840. In an embodiment, the matching at 870 of a sum of cash records in a possible cash group with a selected portfolio record may be characterized as a one-to-many reconciliation pass. If the sum of the cash records in the cash group does not match during the one-to-many reconciliation pass at 870, then it may be determined at 880 if there are additional cash issuer groups. If there are additional cash issuer groups, then matching logic 430 may return to 860 by selecting the next possible cash group by issuer identifier. If at 870 a match between the sum of cash records in the possible cash group matches the selected portfolio record, then matching logic 430 may proceed to 890, whereby a match is created, and a reconciliation identifier is assigned to the cash and portfolio records.

If either there are no additional cash issuer groups determined at 880, or if a match is created at 890, then it may be determined at 900 if there are additional portfolio records to be processed. If so, then matching logic 430 may return to 840 to find the next portfolio record without a reconciliation identifier. If, however, the remaining portfolio records lacking a reconciliation identifier have been processed in the one-to-one reconciliation pass, the many-to-one reconciliation pass, and the one-to-many reconciliation pass, then matching logic 430 may terminate. As indicated above, in some instances exceptions (i.e. unmatched cash and portfolio records) may remain, and may be treated by addition to exception queue 460, for example.

Although in some embodiments a day tolerance is utilized when determining a match, in other embodiments, other tolerance or threshold settings may additionally or alternatively be utilized. For example, in some embodiments, the one-to-one reconciliation performed when determining if the cash and portfolio records match at 700 might proceed only when the cash and portfolio records are within a defined amount tolerance. In some such embodiments, the amount tolerance may be excluded for the many-to-one reconciliation and the one-to-many reconciliation, as described above. In an embodiment, the amount tolerances may generally have associated global definitions. Also as above, in some embodiments, deal-specific amount tolerances may be utilized in lieu of or as an over-ride for the global amount tolerance definitions. In an embodiment, a default amount tolerance may be $0.01, and may be applied to the total amount selected for reconciliation. Besides for tolerances in date and amount, other settings may also or alternatively be utilized in determining whether items are determined to match. For example, in some embodiments zeros might be excluded during the reconciliation process. In some embodiments, this may include leading zeros or trailing zeros. In an embodiment, values may be rounded to a defined significant digit, which may be a part of or separate from the amount tolerance described above. In an embodiment, an absolute value setting may be utilized to determine whether the positive or negative nature of a number should be utilized when determining a match. In an embodiment, if the absolute value setting is true, it might only be utilized during system to system matching, and not from record to record (which might cause problems when summing multiple records in the many-to-one or the one-to-many reconciliations.

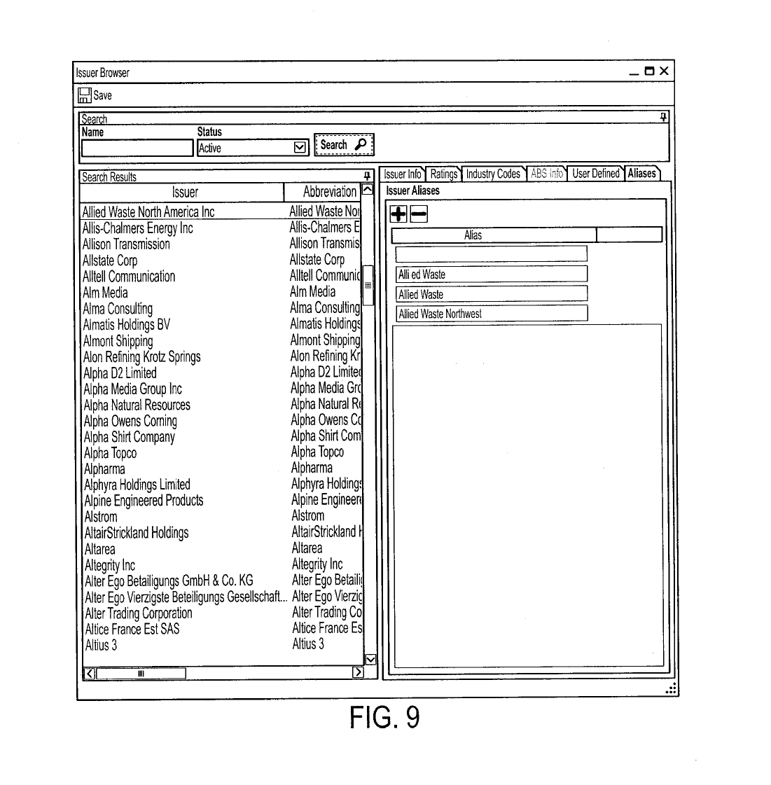

As indicated above, issuer identifier aliases may be defined in issuer alias table 670. An example of such an alias table is depicted in FIG. 9. In various embodiments, issuer alias table 670 may include aliases derived from misspellings of issuer identifiers. In other embodiments, issuer alias table 670 may include aliases that include variations of issuer names, including, for example, nicknames or abbreviations for the issuer identifiers. In some cases, issuers may do business under another name for various investments, so that the issuer aliases may be separate related business entities. In an embodiment, issuer identifications associated with cash system 30 and portfolio system 40 may be provided by separate parties, which may increase a likelihood that variations in the issuer identifier may occur throughout financial service system 10. In some embodiments, issuer aliases may be defined manually, such as through deal setup module 90 in reconciliation system 20 (i.e. when entering other relevant details at 240 in deal setup process 160). In some embodiments, issuer aliases may be automatically defined, such as where common misspellings of issuer names are automatically included as aliases. In an embodiment, exception process 180 may be coupled to issuer alias table 670, whereby issuer data from cash system 30 and/or portfolio system 40 are added as aliases of one another when the user selects items to match at 600. In some such embodiments, the user of reconciliation system 20 may train reconciliation system 20 to recognize new aliases, which may reduce occurrences of exceptions over time. In an embodiment, the issuer alias table 670 may be pre-populated with issuer names from portfolio system 40.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

Various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A system for reconciling financial transactions, the system comprising:
one or more processors configured to:
retrieve first financial data from a first data source, the first financial data containing one or more first records, each containing at least a first name, a first date, and a first monetary amount;
retrieve second financial data from a second data source, the second financial data containing one or more second records, each containing at least a second name, a second date, and a second monetary amount;
attempt to match one of the first records with one of the second records based on (i) equivalence of the first name, or a possible alias of the first name, and the second name, (ii) equivalence within tolerance of the first date and the second date, and (iii) equivalence within tolerance of the first monetary amount and the second monetary amount;
responsive to any of the first records and the second records remaining unmatched, attempt to match two or more of the second records with one of the first records based on (i) equivalence of the first name, and/or possible aliases of the first name, and the second names, (ii) equivalence within tolerance of the first date and the second dates, and (iii) equivalence within tolerance the first monetary amount and a sum of the second monetary amounts; and
responsive to any of the first records and the second records remaining unmatched, attempt to match two or more of the first records with one of the second records based on (i) equivalence of the first names and the second name, (ii) equivalence within tolerance of the first dates and the second date, and (iii) equivalence within tolerance of the sum of the first monetary amounts and the second monetary amount.

2. The system of claim 1, wherein the tolerance of the equivalence within tolerance of the first date(s) and the second date(s) is definable by a user input.

3. The system of claim 1, wherein the tolerance of the equivalence within tolerance of the first monetary amount(s) and the second monetary amount(s) is definable by a user input.

4. The system of claim 1, wherein the one or more processors are further configured to execute an exception process responsive to any of the first and second records remaining unmatched after attempting to match two or more of the first records with one of the second records, wherein the exception process comprises:
displaying unmatched ones of the first and second records; and
receiving user-input designating matches between one or more of the first records and one or more of the second records.

5. The system of claim 4, wherein the possible aliases of the first name are selected from aliases of the second name.

6. The system of claim 5, wherein the exception process further comprises associating the first name as an alias of the second name for the user-input designated match between the one or more of the first records and the one or more of the second records.

7. The system of claim 1, wherein the first financial data and the second financial data are selected from a user-defined date range of financial transactions associated with the first data source and the second data source.

8. The system of claim 1, wherein the first financial data comprises data associated with completed financial transactions, and the second financial data comprises data associated with expected financial transactions.

9. The system of claim 1, wherein the one or more processors are further configured to generate a report based on matched ones of the one or more first records and the one or more second records.

10. The system of claim 1, further comprising a user interface operatively coupled to the one or more processors via a network connection.

11. The system of claim 10, wherein the user interface comprises an Internet web portal.

12. A computer-implemented method for reconciling financial transactions, the method comprising:
retrieving, via one or more processors, first financial data from a first data source, the first financial data containing one or more first records, each containing at least a first name, a first date, and a first monetary amount;
retrieving, via the one or more processors, second financial data from a second data source, the second financial data containing one or more second records, each containing at least a second name, a second date, and a second monetary amount;
attempting to match one of the first records with one of the second records based on (i) equivalence of the first name, or an alias of the first name, and the second name, (ii) equivalence within tolerance of the first date and the second date, and (iii) equivalence within tolerance of the first monetary amount and the second monetary amount;
responsive to any of the first records and the second records remaining unmatched, attempting to match two or more of the second records with one of the first records based on (i) equivalence of the first name, and/or aliases of the first name, and the second names, (ii) equivalence within tolerance of the first date and the second dates, and (iii) equivalence within tolerance the first monetary amount and a sum of the second monetary amounts; and
responsive to any of the first records and the second records remaining unmatched, attempting to match two or more of the first records with one of the second records based on (i) equivalence of the first names and the second name, (ii) equivalence within tolerance of the first dates and the second date, and (iii) equivalence within tolerance of the sum of the first monetary amounts and the second monetary amount.

13. The method of claim 12, further comprising receiving, via a user input, the tolerance of the equivalence within tolerance of the first date(s) and the second date(s).

14. The method of claim 12, further comprising receiving, via a user input, the tolerance of the equivalence within tolerance of the first monetary amount(s) and the second monetary amount(s).

15. The method of claim 12, further comprising executing an exception process responsive to any of the first and second records remaining unmatched after attempting to match two or more of the first records with one of the second records, wherein the exception process comprises:
displaying unmatched ones of the first and second records; and
receiving user-input designating matches between one or more of the first records and one or more of the second records.

16. The method of claim 15, wherein the possible aliases of the first name are selected from aliases of the second name.

17. The method of claim 16, wherein the exception process further comprises associating the first name as an alias of the second name for the received user-input designated match between the one or more of the first records and the one or more of the second records.

18. The method of claim 12, wherein the first financial data and the second financial data are selected from a user-defined date range of financial transactions associated with the first data source and the second data source.

19. The method of claim 12, wherein the first financial data comprises data associated with completed financial transactions, and the second financial data comprises data associated with expected financial transactions.

20. The method of claim 12, further comprising generating a report based on matched ones of the one or more first records and the one or more second records.
